(19) United States
(12) Patent Application Publication
(10) Pub. No.: US 2016/0293316 A1
(43) Pub. Date: Oct. 6, 2016

(54) COIL ELECTRONIC COMPONENT AND METHOD OF MANUFACTURING THE SAME

(71) Applicant: SAMSUNG ELECTRO-MECHANICS CO., LTD., Suwon-si (KR)

(72) Inventors: Moon Soo PARK, Suwon-si (KR); Jin Ok HAN, Suwon-si (KR); Tae Young KIM, Suwon-si (KR); Dong Hwan LEE, Suwon-si (KR); Hye Yeon CHA, Suwon-si (KR); Jong Ho LEE, Suwon-si (KR)

(21) Appl. No.: 15/017,922

(22) Filed: Feb. 8, 2016

(30) Foreign Application Priority Data
Apr. 1, 2015 (KR) 10-2015-0046311

(51) Int. Cl. H01F 27/255; H01F 41/02; H01F 27/28

(52) U.S. Cl. CPC H01F 27/255; H01F 27/2804; H01F 41/02

(57) ABSTRACT

A coil electronic component includes a magnetic body enclosing a coil part and a magnetic metal plate. The magnetic metal plate is arranged in a direction in which magnetic flux flows within the magnetic body.

### CROSS-REFERENCE TO RELATED APPLICATIONS

This application claims the benefit of priority to Korean Patent Application No. 10-2015-0046311, filed on Apr. 1, 2015 with the Korean Intellectual Property Office, the entirety of which is incorporated herein by reference.

### TECHNICAL FIELD

The present inventive concept relates to a coil electronic component and a method of manufacturing the same.

### BACKGROUND

An inductor, a coil electronic component, is a type of passive element that may constitute part of an electronic circuit, together with a resistor and a capacitor, to remove noise.

An inductor may be manufactured by forming a coil part, manufacturing a magnetic body enclosing the coil part, and then forming an external electrode on the exterior of the magnetic body.

### SUMMARY

An aspect of the present inventive concept provides a coil electronic component having high inductance (L) and superior quality factor (Q-factor) and DC-Bias properties (variation features in inductance according to the application of a current).

According to an aspect of the present inventive concept, a coil electronic component includes a magnetic body enclosing a coil part and a magnetic metal plate. The magnetic metal plate is disposed in a direction in which magnetic flux flows within the magnetic body.

According to another aspect of the present inventive concept, a method of manufacturing a coil electronic component comprises steps of: forming a coil part and forming a magnetic body enclosing the coil part. The step of forming the magnetic body includes forming a magnetic metal plate in a direction in which magnetic flux flows within the magnetic body.

According to another aspect of the present inventive concept, a coil electronic component comprises a substrate; a through hole penetrating the central portion of the substrate; a first coil part disposed on a first surface of the substrate; a second coil part disposed on a second surface of the substrate opposite the first surface of the substrate; a magnetic body encapsulating the substrate and the first and second coil parts; and a core part including a plurality of magnetic metal plates and a plurality of metal powder layers disposed alternately with each other, the core part being disposed in a thickness direction of the first and second coil parts.

### BRIEF DESCRIPTION OF THE DRAWINGS

The above and other aspects, features, and advantages of the present inventive concept will be more clearly understood from the following detailed description taken in conjunction with the accompanying drawings,

FIG. 1 is a perspective view illustrating a coil part of a coil electronic component according to an exemplary embodiment of the present inventive concept.

FIG. 2 is a cross-sectional view, taken along line I-I′ of FIG. 1.

FIG. 3 is a cross--sectional view, taken along line II-II′ of FIG. 1.

FIG. 4 is an enlarged view of an example of portion A illustrated in FIG. 2.

FIG. 5 is a perspective view illustrating a laminate including a magnetic metal plate and the coil part of the coil electronic component according to an exemplary embodiment of the present inventive concept.

FIG. 6 is a cross-sectional view illustrating a cross-section of a coil electronic component according to another exemplary embodiment of the present inventive concept, taken in a length-thickness direction (L-T).

FIGS. 7A through 7C are views illustrating processes of manufacturing the coil electronic component in sequence, according to an exemplary embodiment of the present inventive concept.

### DETAILED DESCRIPTION

Hereinafter, embodiments of the present inventive concept will be described as follows with reference to the attached drawings.

The present inventive concept may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “upper,” or “above” other elements would then be oriented “lower,” or “below” the other elements or features. Thus, the term “above” can encompass both the above and below orientations depending on a particular direction the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concept. In the drawings, for example, due to manufacturing techniques and/or tolerances, modifications of the shape shown may be estimated. Thus, embodiments of the present inventive concept should not be construed as being limited to the particular shapes of regions shown herein, for example, to include a change in shape results in manufacturing. The following embodiments may also be constituted by one or a combination thereof.

The contents of the present inventive concept described below may have a variety of configurations and propose only a required configuration herein, but are not limited thereto.

Coil Electronic Component

Hereinafter, a coil electronic component according to an exemplary embodiment of the present inventive concept is explained as a thin film inductor, but is not limited thereto.

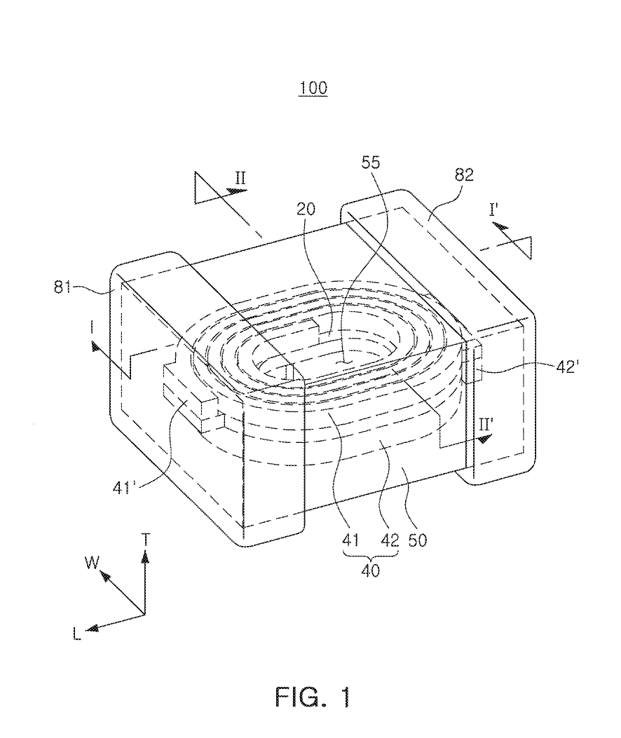

FIG. 1 is a perspective view illustrating a coil electronic component including a coil part according to an exemplary embodiment of the present inventive concept.

FIG. 1 discloses a thin-film power inductor used in a power line of a power supply circuit, as an example of the coil electronic component.

A coil electronic component 100 according to an exemplary embodiment of the present inventive concept may include a coil part 40, a magnetic body 50 enclosing the coil part 40, and first and second external electrodes 81 and 82 disposed on external portions of the magnetic body 50 to be connected to the coil part 40.

In the coil electronic component 100 according to an exemplary embodiment of the present inventive concept, a ‘length’ direction, a ‘width’ direction, and a ‘thickness’ direction are defined as an ‘L’ direction, a ‘W’ direction, and a ‘T’ direction of FIG. 1, respectively.

The coil part 40 may be formed by connecting a first coil conductor 41 formed on a first surface of a substrate 20 and a second coil conductor 42 formed on a second surface opposite to the first surface of the substrate 20 to each other.

Each of the first and second coil conductors 41 and 42 may have a planar coil shape in which it is formed on the same plane of the substrate 20.

The first and second coil conductors 41 and 42 may have spiral shapes.

The first and second coil conductors 41 and 42 may be formed by performing electroplating on the substrate 20, but are not limited thereto.

The first and second coil conductors 41 and 42 may contain a metal having excellent electrical conductivity, and may be formed of, for example, silver (Ag), palladium (Pd), aluminum (Al), nickel (Ni), titanium (Ti), gold (Au), copper (Cu), platinum (Pt) or alloys thereof.

The first and second coil conductors 41 and 42 may be coated with an insulating layer (riot shown) and may not be in direct contact with a magnetic material forming the magnetic body 50.

The substrate 20 may contain, for example, a polypropylene glycol (PPG) substrate, a ferrite substrate, a metallic soft-magnetic substrate, or the like.

A central portion of the substrate 20 may be removed to form a through hole, the through hole being filled with a magnetic material to form a core part 55.

As the core part 55 is filled with a magnetic material, an area of the magnetic body through which magnetic flux passes may be increased to enhance inductance L.

However, the substrate 20 is not necessarily included, and the coil part may be formed using a metal wire without the inclusion of the substrate 20.

The magnetic body 50 enclosing the coil part 40 may contain any magnetic material without limitation, as long as the magnetic material exhibits magnetic properties. For example, the magnetic material may contain a ferrite material or magnetic metal powder.

In accordance with an increase in magnetic permeability of the magnetic material contained in the magnetic body 50 and an increase in the area of the magnetic body 50 through which magnetic flux passes, inductance L may be increased.

One end portion of the first coil conductor 41 may be extended to form a first lead-out portion 41′, and the first lead-out portion 41′ may be exposed to one end surface of the magnetic body 50 in the length (L) direction. One end portion of the second coil conductor 42 may be extended to form a second lead-out portion 42′, and the second lead-out portion 42′ may be exposed to the other end surface of the magnetic body 50 in the length (L) direction.

However, the present inventive concept is not limited thereto, and the first and second lead-out portions 41′ and 42′ may be exposed to at least one surface of the magnetic body 50.

The first and second external electrodes 81 and 82 may be formed on external portions of the magnetic body 50 to be connected to the first and second lead-out portions 41′ and 42′ exposed to the end surfaces of the magnetic body 50, respectively.

The first and second external electrodes 81 and 82 may contain a metal having excellent electrical conductivity, such as copper (Cu), silver (Ag), nickel (Ni), tin (Sn), or the like, alone or in combination.

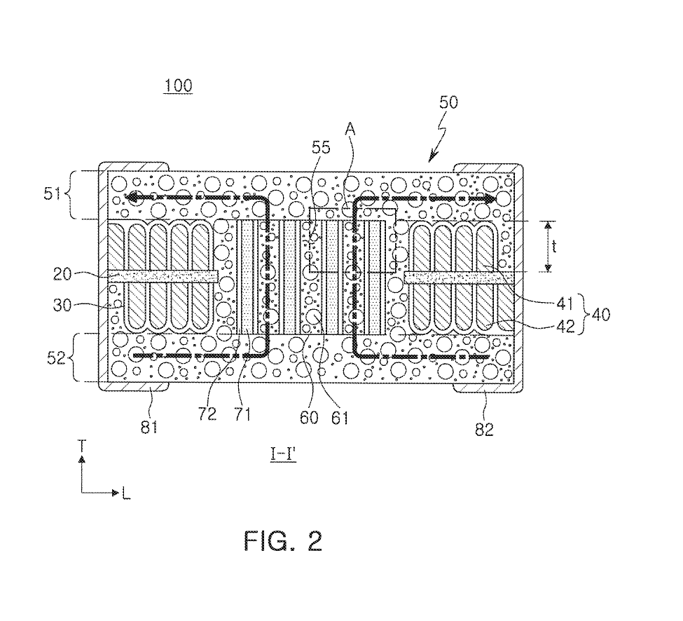

FIG. 2 is a cross-sectional view, taken along line of FIG. 1.

Referring to FIG. 2, in the coil electronic component 100 according to an exemplary embodiment of the present inventive concept, magnetic metal plates 71 may be disposed within the magnetic body 50. The magnetic metal plates 71 disposed within the magnetic body 50 may be arranged in a direction in which magnetic flux flows within the magnetic body.

Since the magnetic metal plates 71 have significantly high magnetic permeability of approximately two to ten times that of the magnetic metal powder 61, the magnetic metal plates 71 having high magnetic permeability may be disposed within the magnetic body 50 to thereby increase the level of inductance.

Meanwhile, the magnetic permeability of the magnetic metal plates 71 may vary depending on a direction. Thus, even when the overall magnetic permeability of the magnetic metal plates 71 is higher than that of the magnetic metal powder 61, the magnetic permeability of the magnetic metal plates 71 in a specific direction may be lower, which could interrupt a flow of magnetic flux generated by a current applied to the coil part, thereby resulting in a decrease in inductance.

Accordingly, according to an exemplary embodiment of the present inventive concept, the magnetic metal plates 71 having high magnetic permeability may be disposed within the magnetic body 50 while being arranged in a direction in which magnetic flux flows to allow for a smooth flow of magnetic flux, and due to the high magnetic permeability of the magnetic metal plates 71, a level of inductance may be effectively increased.

In the coil electronic component 100 according to an exemplary embodiment of the present inventive concept, illustrated in FIG. 2, the magnetic metal plates 71 may be disposed in the core part 55 formed inwardly from the coil part 40.

In the core part 55, magnetic flux may flow in a direction parallel to a thickness (t) direction of the coil part 40. Thus, in the coil electronic component 100 according to an exemplary embodiment of the present inventive concept, the magnetic metal plates 71 may be arranged to be parallel to the thickness (t) direction of the coil part 40 in the core part 55.

The magnetic metal plates 71 may be formed of a crystalline or amorphous metal containing one or more selected from the group consisting of iron (Fe), silicon (Si), boron (B), chromium (Cr), aluminum (Al), copper (Cu), niobium (Nb), and nickel (Ni).

According to an exemplary embodiment of the present inventive concept, the magnetic metal plates 71 may be alternately stacked with magnetic metal powder layers 60 containing the magnetic metal powder 61 and a thermosetting resin.

When only a plurality of magnetic metal plates are arranged, high magnetic permeability may be exhibited, but core loss due to an eddy current may be significantly increased resulting in a deterioration of high frequency characteristics such as Q-factor properties.

Accordingly, according to an exemplary embodiment of the present inventive concept, the plurality of magnetic metal plates 71 are alternately stacked with the magnetic metal powder layers 60, whereby high magnetic permeability may be implemented, and, at the same time, core loss may be reduced.

The magnetic metal powder 61 may include spherical powder particles or flake powder particles having flake shapes.

When the magnetic metal powder 61 includes shape isotropic spherical powder particles, there is no limitation in arranging the magnetic metal powder 61 because it may have the same magnetic permeability in each of the x-axis, y-axis, and z-axis.

However, when the magnetic metal powder 61 includes shape anisotropic flake powder particles, it may be preferable to dispose one axis of plate surfaces of particles of the magnetic metal powder 61 with shape anisotropy in a direction in which magnetic flux flows so as not to interrupt the flow of magnetic flux, because levels of magnetic permeability may be different in the x-axis, y-axis and z-axis.

The magnetic metal powder 61 may be formed of a crystalline or amorphous metal containing one or more selected from the group consisting of iron (Fe), silicon (Si), boron (B), chromium (Cr), aluminum (Al), copper (Cu), niobium (Nb), and nickel (Ni).

For example, the magnetic metal powder 51 may be formed of Fe—Si—B—Cr based amorphous metal particles having spherical shapes.

The magnetic metal powder 61 may be included in a form in which magnetic metal powder particles are dispersed in a thermosetting resin such as an epoxy resin, polyimide, or the like.

Meanwhile, the magnetic metal powder 61 may include magnetic metal powder particles having a relatively large average particle diameter and magnetic metal powder particles having a relatively small average particle diameter.

The magnetic metal powder particles having a relatively large average particle diameter may implement higher magnetic permeability, and the magnetic metal powder particles having a relatively small average particle diameter may be mixed with the magnetic metal powder particles having a large average particle diameter to improve density (filling rate). In accordance with the improvement in density, magnetic permeability may be increased.

When magnetic metal powder particles having a large average particle diameter are used, high magnetic permeability may be implemented, but core loss may be increased. Since magnetic metal powder particles having a small average particle diameter are low loss materials, they may be mixed with the magnetic metal powder particles having a large average particle diameter to counteract the core loss increased from the use of the magnetic metal powder particles having a large average particle diameter, thereby improving Q-factor properties.

A thermosetting resin layer 72 may be formed on at least one surface of the magnetic metal plate 71.

Accordingly, according to an exemplary embodiment of the present inventive concept, the magnetic metal plate 71, the thermosetting resin layer 72, and the magnetic metal powder layer 60 may be stacked in sequence, and the coil electronic component 100 according to an exemplary embodiment of the present inventive concept may simultaneously implement high magnetic permeability and reduce core loss.

The magnetic body 50 of the coil electronic component 100 according to an exemplary embodiment of the present inventive concept may contain the magnetic metal powder 61 in first and second cover parts 51 and 52 formed with the coil part 40 disposed therebetween.

The magnetic metal powder 61 contained in the first and second cover parts 51 and 52 may be included in a form in which magnetic metal powder particles are dispersed in a thermosetting resin such as an epoxy resin, polyimide, or the like. The magnetic metal powder 61 may include magnetic metal powder particles having a large average particle diameter and magnetic metal powder particles having a small average particle diameter mixed with each other.

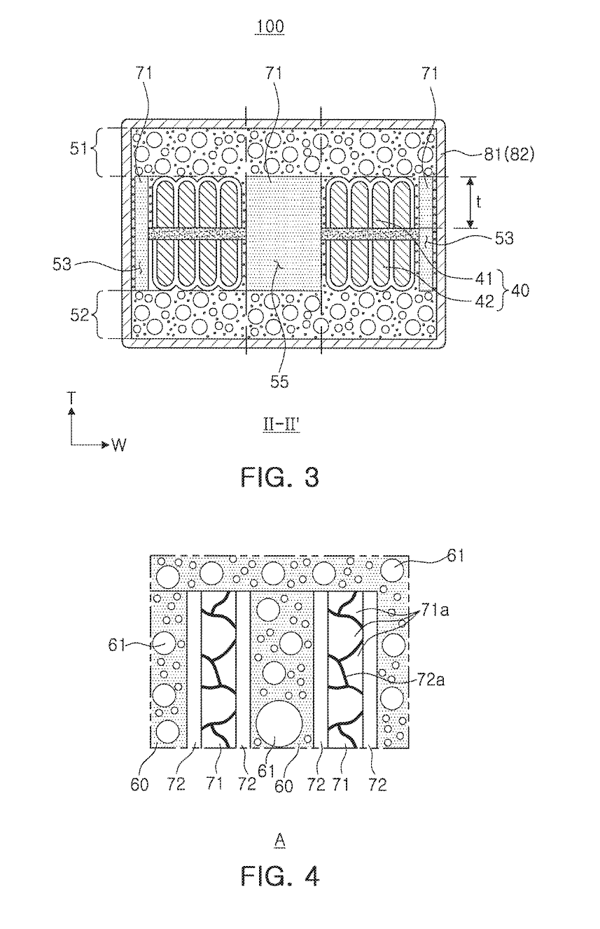

FIG. 3 is a cross-sectional view, taken along line II-II′ of FIG. 1.

Referring to FIG. 3, in the coil electronic component 100 according to an exemplary embodiment of the present inventive concept, the magnetic metal plate 71 may be disposed in the core part 55 formed inwardly of the coil part 40 and an outer circumferential portion 53 formed outwardly of the coil part 40.

However, the present inventive concept is not limited thereto, and the magnetic metal plate 71 may be disposed in one or more of the core part 55 and the outer circumferential portion 53.

In the outer circumferential portion 53, similar to the core part 55, magnetic flux may flow in a direction parallel to the thickness (t) direction of the coil part 40. Thus, in the coil electronic component 100 according to an exemplary embodiment of the present inventive concept, the magnetic metal plate 71 may be arranged to be parallel to the thickness (t) direction of the coil part 40 in the outer circumferential portion 53.

Similarly to the magnetic metal plate 71 disposed in the core part 55, the magnetic metal plate 71 disposed in the outer circumferential portion 53 may be alternately stacked with the magnetic metal powder layer 60 containing the magnetic metal powder 61 and the thermosetting resin, and the thermosetting resin layer 72 may be formed on at least one surface of the magnetic metal plate 71.

FIG. 4 is an enlarged view of an example of portion A illustrated in FIG. 2.

Referring to FIG. 4, the magnetic metal plate 71 according to an exemplary embodiment of the present inventive concept may be broken and be formed of a plurality of metal pieces 71a.

Although the magnetic metal plate 71 has significantly high magnetic permeability of approximately two to ten times that of the magnetic metal powder 61, core loss due to an eddy current may be significantly eased resulting in a deterioration of Q-factor properties when the magnetic metal plate 71 having a plate shape is not broken and is used as is.

Accordingly, according to an exemplary embodiment of the present inventive concept, the magnetic metal plate 71 is broken to form the plurality of metal pieces 71a, whereby high magnetic permeability may be implemented, and, at the same time, core loss may be reduced.

Thus, in the coil electronic component 100 according to an exemplary embodiment of the present inventive concept, magnetic permeability may be improved to secure high inductance while superior Q-factor properties may be satisfied.

The magnetic metal plate 71 may be broken in such a manner that adjacent metal pieces 71a have corresponding shapes.

Since the metal pieces 71a formed by breaking the magnetic metal plate are positioned to form a layer in a state in which they are broken, rather than being irregularly dispersed, the adjacent metal pieces 71a may have corresponding shapes.

The adjacent metal pieces 71a having corresponding shapes does not mean that the adjacent metal pieces 71a completely match with each other. The metal pieces 71a may be positioned to form a layer in a state in which they are broken.

A thermosetting resin 72a may fill a space between the adjacent metal pieces 71a of the broken magnetic metal plate 71.

The thermosetting resin 72a may be formed by infiltrating the thermosetting resin of the thermosetting resin layer 72 formed on one surface of the magnetic metal plate 71 into a space between the adjacent metal pieces 71a during processes of compressing and breaking the magnetic metal plate 71.

The thermosetting resin 72a filling the space between the adjacent metal pieces 71a may insulate the adjacent metal pieces 71a from each other.

Accordingly, core loss of the magnetic metal plate 71 may be reduced to improve Q-factor properties.

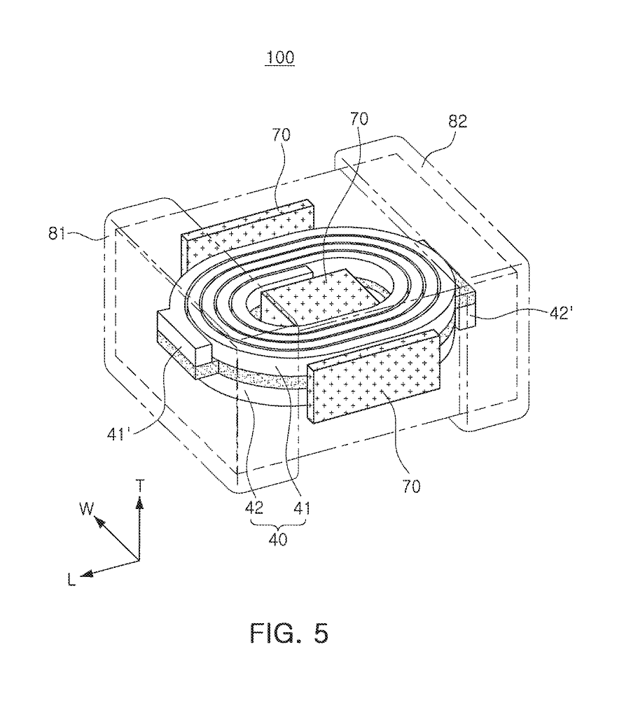

FIG. 5 is a perspective view illustrating a laminate including the magnetic metal plate and the coil part of the coil electronic component according to an exemplary embodiment of the present inventive concept.

Referring to FIG. 5, in the coil electronic component 100 according to an exemplary embodiment of the present inventive concept, a laminate 70 including the magnetic metal plate 71 in the core part 55 and the outer circumferential portion 53 may be disposed.

The laminate 70 may be formed by alternately stacking the magnetic metal plate 71 and the magnetic metal powder layer 60 containing the magnetic metal powder 61 and the thermosetting resin.

As illustrated in FIG. 5, the laminate 70 may be disposed in one or more of the core part 55 and the outer circumferential portion 53. Thus, the magnetic metal plate 71 may be formed in the core part 55 and/or the outer circumferential portion 53.

In this case, the magnetic metal plate 71 included in the laminate 70 may be arranged to be parallel to the thickness (t) direction of the coil part 40 in such a manner that it may be disposed in a direction in which magnetic flux flows within the magnetic body.

FIG. 5 illustrates case in which a structure of the coil electronic component 100 according to an exemplary embodiment of the present inventive concept is implemented by disposing the laminate 70 including the magnetic metal plate 71, but the present inventive concept is not limited thereto.

Any method capable of realizing the structure of the coil electronic component 100 according to an exemplary embodiment of the present inventive concept may be used.

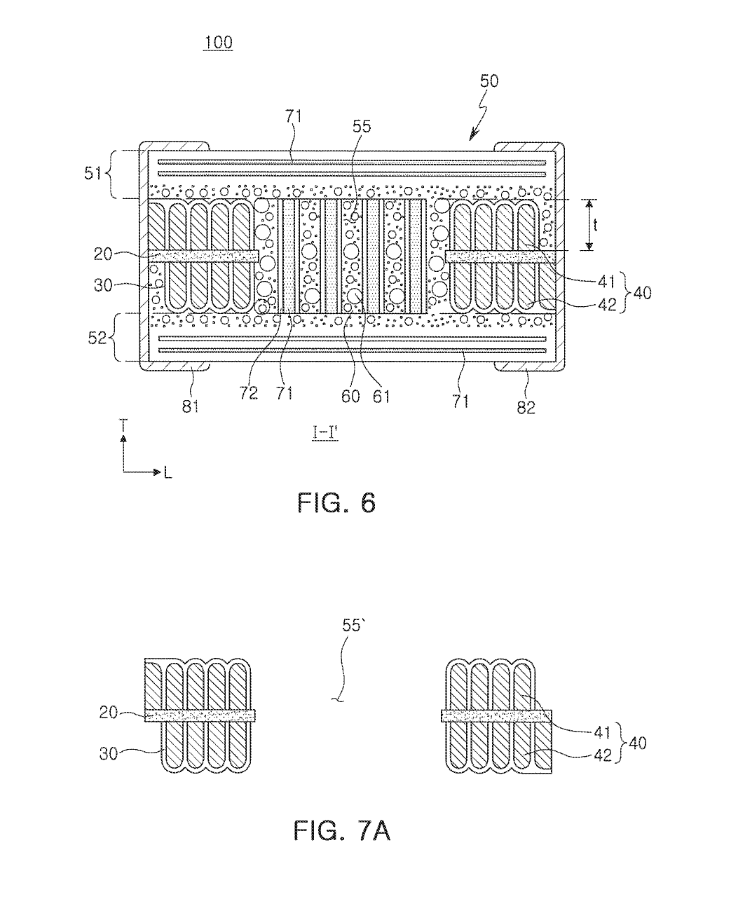

FIG. 6 is a cross-sectional view illustrating a cross-section of a coil electronic component according to another exemplary embodiment of the present inventive concept, taken in a length-thickness direction (L-T).

Referring to FIG. 6, in the coil electronic component 100 according to another exemplary embodiment of the present inventive concept, the magnetic metal plates 71 may be disposed in the first and second cover parts 51 and 52.

In the first and second cover parts 51 and 52, magnetic flux may flow in a direction perpendicular to the thickness (t) direction of the coil part 40. Thus, in the coil electronic component 100 according to another exemplary embodiment of the present inventive concept, the magnetic metal plates 71 may be arranged to be perpendicular to the thickness (t) direction of the coil part 40 in the first and second cover parts 51 and 52.

In the coil electronic component 100 according to another exemplary embodiment of the present inventive concept, the magnetic metal plates 71 may be disposed in the core part 55 and/or the outer circumferential portion 53 as well as in the first and second cover parts 51 and 52.

In the core part 55 and/or the outer circumferential portion 53, magnetic flux may flow in a direction parallel to the thickness (t) direction of the coil part 40. Thus, in the coil electronic component 100 according to another exemplary embodiment of the present inventive concept, the magnetic metal plates 71 may be arranged to be parallel to the thickness (t) direction of the coil part 40 in the core part 55 and/or the outer circumferential portion 53.

In this manner, the magnetic metal plates 71 may be disposed within the magnetic body 50 while being arranged in a direction in which magnetic flux flows to allow for smooth flow of the magnetic flux, and due to the high magnetic permeability of the magnetic metal plates 71, a level inductance may be effectively increased.

Except for the configuration of the magnetic metal plates 71 disposed in the first and second over parts 51 and 52, configurations overlapping those of the coil electronic component 100 according to an exemplary embodiment of the present inventive concept may be applied in the same manner.

Method of Manufacturing Coil Electronic Component

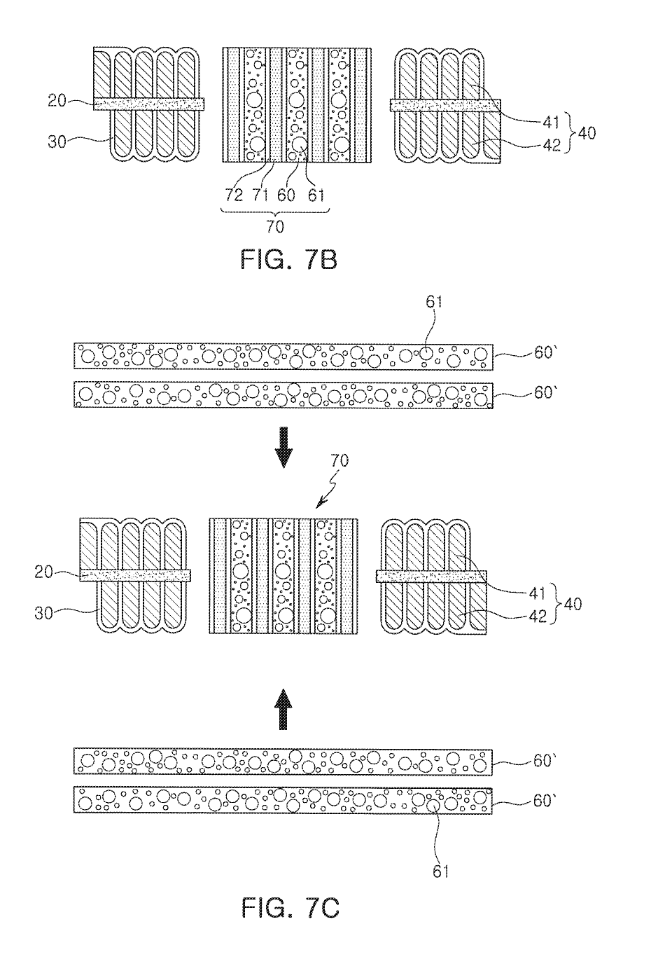

FIG. 7A through 7C are views illustrating processes of manufacturing the coil electronic component in sequence according to an exemplary embodiment of the present inventive concept.

Referring to FIG. 7A, the coil part 40 may first be formed.

After a via hole (not shown) is formed in the substrate 20 and a plating resist (not shown) having an opening is formed on the substrate 20, the via hole and opening may be filled with a conductive metal by a plating method to thereby form the first and second coil conductors 41 and 42, and a via (not shown) connecting the coil conductors may be formed.

The first and second coil conductors 41 and 42 and the via may be formed of a conductive metal having excellent electrical conductivity such as silver (Ag), palladium (Pd), aluminum (Al), nickel (Ni), titanium (Ti), gold (Au), copper (Cu), platinum (Pt) or alloys thereof.

However, a method of forming the coil part 40 is not limited to such a plating process. The coil part may be formed using a metal wire, and any material may be applied, as long as the material has a form capable of generating magnetic flux by a current applied thereto.

An insulating layer 30 covering the first and second coil conductors 41 and 42 may be formed on the first and second coil conductors 41 and 42.

The insulating layer 30 may contain, for example, a polymer material such as an epoxy resin or a polyimide resin, photo resist (PR), a metal oxide, or the like, but is not necessarily limited thereto. Any insulating material may be used, as long as the insulating material encloses the first and second coil conductors 41 and 42 to prevent shorts.

The insulating layer 30 may be formed by a screen printing method, an exposure or development process of photoresist (PR), a spray coating process, oxidization through the chemical etching of the coil conductor, or the like.

In the substrate 20, a central portion of a region. in which the first and second coil conductors 41 and 42 are not formed may be removed to form a core hole 55′.

The removal of the substrate 20 may be performed by a mechanical drilling process, a laser drilling process, sand-blasting process, a punching process, or the like.

Referring to FIG. 7B, the laminate 70 including the magnetic metal plates 71 may be disposed in the core hole 55′ formed inwardly of the coil part 40 and/or an outer circumferential hole (not shown).

The laminate 70 may be formed by alternately stacking the magnetic metal plates 71 and the magnetic metal powder layers 60 containing the magnetic metal powder 61 and the thermosetting resin.

The thermosetting resin layer 72 may be formed on at least one surface of the magnetic metal plates 71. Accordingly, the laminate 70 may be formed by stacking the magnetic metal plate 71, the thermosetting resin layer 72, and the magnetic metal powder layer 60 in sequence.

The magnetic metal plates 71 may be arranged in a direction in which magnetic flux flows.

In the core part 55 and the outer circumferential portion 53, magnetic flux flows in a direction parallel to the thickness (t) direction of the coil part 40. Thus, the magnetic metal plates 71 formed in the core part 55 and/or the outer circumferential portion 53 may be arranged to be parallel to the thickness (t) direction of the coil part 40.

The method of manufacturing the coil electronic component may further include forming the plurality of metal pieces 71a by breaking the magnetic metal plates 71.

Since the metal pieces 71a formed by breaking the magnetic metal plates are positioned to form a layer in a state in which they are broken, rather than being irregularly dispersed, the adjacent metal pieces 71a may have corresponding shapes.

The thermosetting resin 72a may fill a space between the adjacent metal pieces 71a of the broken magnetic metal plate 71.

The thermosetting resin 72a may be formed by infiltrating the thermosetting resin of the thermosetting resin layer 72 formed on one surface of the magnetic metal plate 71 into a space between the adjacent metal pieces 71a during processes of compressing and breaking the magnetic metal plates 71.

The thermosetting resin 72a filling the space between the adjacent metal pieces 71a may insulate the adjacent metal pieces 71a from each other.

Accordingly, core loss of the magnetic metal plate 71 may be reduced to improve Q-factor properties.

FIG. 7B illustrates a case in which the coil electronic component 100 according to an exemplary embodiment of the present inventive concept as described above is manufactured by disposing the laminate 70 including the magnetic metal plate 71 in the core part 55′ and/or the outer circumferential hole (not shown), but the present inventive concept is not limited thereto. Any method may be used, as long as the method is capable of realizing the structure of the coil electronic component 100 according to an exemplary embodiment the present inventive concept.

Referring to FIG. 7C, the magnetic body 50 enclosing the coil part 40 may be formed by stacking the sheets 60′ including the magnetic metal powder 61 on upper and lower portions of the coil part 40 and then compressing and curing the sheets.

The sheets 60′ may be manufactured in sheet shapes by mixing the magnetic metal powder 61, a thermosetting resin, and organic materials such as a binder and a solvent to prepare slurry, applying the slurry to carrier films at a thickness of several tens of μm by a doctor blade method, and then performing drying thereon.

The sheets 60′ may be manufactured in a form in which particles of the magnetic metal powder 61 are dispersed in a thermosetting resin such as an epoxy resin, polyimide, or the like.

The remaining portion except for a portion in which the laminate 70 including the magnetic metal plates 71 is disposed may be filled with the magnetic metal powder 61.

FIG. 7C illustrates the method of manufacturing the coil electronic component having a structure in which the magnetic metal powder 61 is contained in the first and second cover parts 51 and 52 formed with the coil part 40 disposed therebetween, but the present inventive concept is not limited thereto. The magnetic metal plates 71 may be further formed in the first and second cover parts 51 and 52 by stacking the sheets 60′ including the magnetic metal powder 61 on upper and lower portions of the coil part 40, stacking the magnetic metal plates 71, and then compressing and curing the sheets.

In the first and second cover parts 51 and 52, magnetic flux may flow in a direction perpendicular to the thickness (t) direction of the coil part 40. Thus, the magnetic metal plates 71 formed in the first and second cover parts 51 and 52 may be disposed to be perpendicular to the thickness (t) direction of the coil part 40. In addition, when the magnetic metal powder 61 includes flake powder particles with shape anisotropy, since levels of magnetic permeability may be different in the x-axis, y-axis and z-axis, it may be preferable to dispose one axis of plate surfaces of particles of the magnetic metal powder 61 with shape anisotropy in a direction in which magnetic flux flows, so as not to interrupt the flow of magnetic flux.

A process of forming the magnetic body 50 enclosing the coil part 40 by forming the laminate 70 including the magnetic metal plates 71 and stacking the sheets 60′ including the magnetic metal powder 61 is described as the method of manufacturing the coil electronic component according to an exemplary embodiment of the present inventive concept, but the present inventive concept is not limited thereto. Any method may be used, as long as the method is capable of forming a metal powder-resin complex having the structure of the coil electronic component 100 according to an exemplary embodiment of the present inventive concept.

Then, the first and second external electrodes 81 and 82 may be formed on external portions of the magnetic body 50 to be connected to the coil part 40.

Except for the above description, a description overlapping that of the coil electronic component 100 according to an exemplary embodiment of the present inventive concept as explained above will be omitted herein.

As set forth above, according to an exemplary embodiment of the present inventive concept, high inductance may be secured and superior quality factor (Q-factor) and DC-Bias properties may be implemented.

While exemplary embodiments have been shown and described above, it will be apparent to those skilled in the art that modifications and variations could be made without departing from the scope of the invention as defined by the appended claims.

What is claimed is:

1. A coil electronic component comprising a magnetic body enclosing a coil part and a core part,
wherein the core part comprises a magnetic metal plate arranged in a direction in which magnetic flux flows within the magnetic body.

2. The coil electronic component of claim 1, wherein the magnetic metal plate is disposed in one or more selected from a group consisting of a core part formed inwardly of the coil part and an outer circumferential portion formed outwardly of the coil part.

3. The coil electronic component of claim 2, wherein the magnetic metal plate is disposed parallel to a thickness direction of the coil part.

4. The coil electronic component of claim 1, wherein the magnetic metal plate is disposed in first and second cover parts formed with the coil part disposed therebetween.

5. The coil electronic component of claim 4, wherein the magnetic metal plate is disposed perpendicular to a thickness direction of the coil part.

6. The coil electronic component of claim 1, wherein the magnetic metal plate is alternately stacked with a magnetic metal powder layer containing magnetic metal powder and a thermosetting resin.

7. The coil electronic component of claim 1, wherein a thermosetting resin layer is formed on at least one surface of the magnetic metal plate.

8. The coil electronic component of claim 1, wherein the magnetic metal plate is broken and comprises a plurality of metal pieces.

9. The coil electronic component of claim 8, wherein a thermosetting resin is disposed between the metal pieces adjacent to each other.

10. The coil electronic component of claim 8, wherein the magnetic metal plate is broken in such a manner that the metal pieces adjacent to each other have corresponding shapes.

11. The coil electronic component of claim 1, wherein the coil part has a planar coil shape in which a coil pattern is formed on a single plane.

12. The coil electronic component of claim 6, wherein the metal powder layer contains spherical powder particles and flake powder particles having a flake shape.

13. A method of manufacturing a coil electronic component, the method comprising steps of:
forming a coil part; and
forming a magnetic body enclosing the coil part,
wherein the step of forming the magnetic body includes forming a magnetic metal plate in a direction in which magnetic flux flows within the magnetic body.

14. The method of claim 13, wherein the magnetic metal plate is disposed in one or more selected from a group consisting of a core part formed inwardly of the coil part and an outer circumferential portion formed outwardly of the coil part.

15. The method of claim 14, wherein the magnetic metal plate is disposed parallel to a thickness direction of the coil part.

16. The method of claim 13, further comprising forming a plurality of metal pieces by breaking the magnetic metal plate.

17. The method of claim 16, wherein a thermosetting resin is disposed between the metal pieces adjacent to each other.

18. A coil electronic component comprising:
a substrate;
a through hole penetrating the central portion of the substrate;
a first coil part disposed on a first surface of the substrate;
a second coil part disposed on a second surface of the substrate opposite the first surface of the substrate;
a magnetic body encapsulating the substrate and the first and second coil parts; and
a core part including a plurality of magnetic metal plates and a plurality of metal powder layers disposed alternately with each other, the core part being disposed in a thickness direction of the first and second coil parts.

19. The coil electronic component of claim 18, further comprising a plurality of thermosetting resin layers interposed between adjacent magnetic metal plates and metal powder layers among the plurality of magnetic metal plates and the plurality of magnetic metal powder layers.

20. The coil electronic component of claim 18, wherein the plurality of magnetic metal plates includes broken magnetic metal plates comprising metal pieces and a thermosetting resin.
